(19) United States
(12) Patent Application Publication
(10) Pub. No.: US 2014/0246384 A1
(43) Pub. Date: Sep. 4, 2014

(54) Nanoparticle-Based Desalination and Filtration System

(71) Applicant: The University of Chicago, Chicago, IL (US)

(72) Inventors: Heinrich M. Jaeger, Chicago, IL (US); Jinbo He, Chicago, IL (US); Xiao-Min Lin, Naperville, IL (US)

(73) Assignee: THE UNIVERSITY OF CHICAGO, Chicago, IL (US)

(21) Appl. No.: 14/351,709

(22) PCT Filed: Nov. 14, 2012
(86) PCT No.: PCT/US2012/065074

§ 371 Date: Apr. 14, 2014

Related U.S. Application Data
(60) Provisional application No. 61/559,555, filed on Nov. 14, 2011.

(51) Int. Cl. B01D 29/00; C02F 1/00

(52) U.S. Cl. CPC B01D 29/00; C02F 1/00; B01D 29/0093
USPC 210/767; 210/490; 210/506; 156/242; 264/299

(57) ABSTRACT

Embodiments of films and filters comprising nanoparticles, (e.g., in which each of a plurality of nanoparticles comprises a core surrounded by a ligand and/or where the diameter of each of at least some of nanoparticles is less than about 50 nm), and methods of making and using such films and filters.

This application claims the benefit of priority to U.S. Provisional Patent Application Serial No. 61/559,555, filed Nov. 14, 2011, hereby incorporated by reference in its entirety.

### FIELD OF THE INVENTION

The present invention relates generally to nanoparticles and, more particularly, but not by way of limitation, to films and filters comprising nanoparticles (e.g., in which each of a plurality of nanoparticles comprises a core substantially surrounded by a ligand, where the diameter of each nanoparticle is less than about 50 nm, and where the effective pore diameter between substantially all nanoparticles is less than about 7 nm).

More specifically, the present invention relates to films and filters comprising such nanoparticles that are configured to allow passage of a liquid solvent, such as water, through interstitial pores between the nanoparticles, but to reject all particles dispersed in this liquid if they have an effective diameter larger than the effective pore diameter, and to reject at least 20% of charged solutes or particles with an effective diameter less than the effective pore diameter. These solutes or particles can include, but are not limited to, ions, proteins, polymers, vitamins, nanoparticles, viruses, antibiotics, and DNA.

### SUMMARY

In certain embodiments, films are disclosed comprising a plurality of nanoparticles, each nanoparticle comprising a core substantially surrounded by a ligand; and a plurality of pores each formed by interstices between three or more adjacent nanoparticles, each pore having an effective pore diameter; where the diameter of each core is less than or equal to about 50 nm and the effective diameter of each of the pores is between about 0.5 nm and about 7 nm; and where the film is configured to reject at least about 20% of charged ions or molecules with a diameter less than the effective pore diameter, while rejecting substantially all molecules or particles with an effective diameter larger than the effective pore diameter.

In certain embodiments of such films, in each of at least some of the nanoparticles, the core is selected from the group consisting of: Au, Fe/Fe₃O₄, CoO, SiO₂, and CdSe. In some embodiments, in at least some of the nanoparticles, the core is selected from the class consisting of clay (i.e., aluminum silicates with other molecules). Further, in each of at least some of the nanoparticles, the ligand is selected from the group consisting of: dodecanethiol, alkythiol, oleylamine, and oleic acid. In other embodiments, the ligand may be selected from any class of alkane thiols.

In specific embodiments, in each of at least some of the nanoparticles, the core comprises Au and the ligand comprises dodecanethiol. In other embodiments, in each of at least some of the nanoparticles, the core comprises Fe/Fe3O4 and the ligand comprises oleylamine. In still other embodiments, in each of at least some of the nanoparticles, the core comprises CoO and the ligand comprises oleic acid.

Embodiments of films may be configured to reject substantially all molecules having an effective diameter greater than or equal to 1.7 nm. Certain specific embodiments of films may be configured to reject at least about 45% of charged ions or molecules having an effective diameter less than about 1.6 nm. In addition, embodiments of films may be configured to remove at least about 20% of NaCl from salt water passed through the film.

Other embodiments of films are disclosed, comprising: a plurality of first nanoparticles each comprising a first core substantially surrounded by a first ligand; and a plurality of second nanoparticles each comprising a second core substantially surrounded by a second ligand; where the first core and the second core comprise different material and the first ligand and the second ligand comprise different material; and where the diameter of each of the first and second nanoparticles is less than or equal to about 20 nanometers and the effective diameter of each of the pores is between about 1 nm and about 7 nm.

In certain embodiments, in each of at least some of the first and second nanoparticles, the first core and second core are selected from the group consisting of Au, Fe/Fe₃O₄, CoO, SiO₂, and CdSe. In addition, in each of at least some of the first and second nanoparticles, the first ligand and second ligand are selected from the group consisting of: dodecanethiol, alkythiol, oleylamine, and oleic acid. Embodiments of such films may be configured to reject objects having an effective diameter greater than or equal to 1.7 nm.

In certain embodiments, the film may be configured to reject at least about 45% of charged molecules having an effective diameter less than about 1.6 nm. In specific embodiments, the film may be configured to remove at least about 20% of NaCl from salt water passed through the film.

In some embodiments of the film, each of the first nanoparticles has a first diameter, and each of the second nanoparticles has a second diameter that is not equal to the first diameter.

Filters are also disclosed. One or more of the films described above may be coupled another of the films and/or coupled to a support structure to form a filter. In specific embodiments, the thickness of the filter is less than or equal to about 100 nm. In other embodiments, the thickness of the filter may be less than 90 nm, 80 nm, 70 nm, 60 nm, 50 nm, 40 nm, or 30 nm.

Methods of filtering are also disclosed, comprising the steps of passing a liquid through any of the embodiments of the films or filters described above. In certain embodiments, the liquid contains of a mixture of solutes or molecules or particles whereby the filter selectively removes one or more components while letting others pass through.

Methods of concentrating are also disclosed, comprising the steps of passing a liquid through any of the embodiments of the films or filters described above and retaining a concentrated solution on the feed side.

In addition, methods of making a filter are disclosed comprising distributing a solution comprising a liquid and a plurality of nanoparticles and permitting the liquid to evaporate such that the nanoparticles form a film. In still other embodiments, the method may further comprise permitting the liquid to evaporate such that the nanoparticles form a plurality of films. In still other embodiments, the method further comprises coupling a plurality of the films together to form a filter.

The term “coupled” is defined as connected, although not necessarily directly, and not necessarily mechanically.

The terms “a” and “an” are defined as one or more unless this disclosure explicitly requires otherwise.

The term “substantially” and its variations (e.g. “approximately” and “about”) are defined as being largely but not necessarily wholly what is specified (and include wholly what is specified) as understood by one of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. For example, a filter that includes two film layers possesses at least two film layers, and also may possess more than two film layers.

Furthermore, a device or structure that is configured in a certain way is configured in at least that way, but may also be configured in ways that are not listed. Metric units may be derived from the English units provided by applying a conversion and rounding to the nearest millimeter.

The present disclosure includes various embodiments of films and filters comprising nanoparticles, as well as methods of using and making such films and filters.

The feature or features of one embodiment may be applied to other embodiments, even though not described or illustrated, unless expressly prohibited by this disclosure or the nature of the embodiments.

Any embodiment of any of the disclosed devices and methods can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Other features and associated advantages will become apparent with reference to the following detailed description of specific embodiments in connection with the accompanying drawings.

### BRIEF DESCRIPTION OF THE DRAWINGS

The following drawings illustrate by way of example and not limitation. For the sake of brevity and clarity, every feature of a given structure may not be labeled in every figure in which that structure appears. Identical reference numbers do not necessarily indicate an identical structure. Rather, the same reference number may be used to indicate a similar feature or a feature with similar functionality, as may non-identical reference numbers. The embodiments of the present grains shown in the figures are drawn to scale for at least the depicted embodiment.

FIG. 1 is a logarithmic plot of rejection rate as a function of valency of certain objects in aqueous solution for an embodiment of a filter comprising nanoparticles. The salts listed from left to right are: Magnesium Chloride (MgCl2), Magnesium Nitrate (Mg(NO3)2), Magnesium Sulfate (MgSO4), Sodium Chloride (NaCl), Potassium Chloride (KCl), Potassium Perchlorate (KClO4), Sodium Bicarbonate (NaHCO3), Potassium Bicarbonate (KHCO3), Sodium Sulfate (Na2SO4), Potassium Sulfate (K2SO4), Citric Acid Trisodium Salt (Na3C6H5O7/Na3Citrate), 1,3,6,8-Pyrenetetrasulfonic Acid (Na4PTS).

FIG. 2 is a logarithmic plot of measured resistance as a function of NaCl concentration showing a 40% reduction in NaCl concentration in saltwater.

FIG. 3 is a logarithmic plot of rejection rate as a function of valency for certain objects for an embodiment of a filter comprising nanoparticles.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Embodiments of films are disclosed that comprise self-assembled free-standing films of close-packed nanoparticles. In certain embodiments, these films may be coupled to a support structure and configured for use as a filter, and more specifically configured for use in desalination processes.

Each nanoparticle within a film comprises a core surrounded (or substantially surrounded by) at least one layer of ligand. In some embodiments, the core may comprise Au, Ag, Fe/Fe₃O₄, CoO, SiO₂, and CdSe. In some embodiments, in at least some of the nanoparticles, the core is selected from the class consisting of clay (i.e., aluminum silicates with other molecules). In certain embodiments, the ligands may comprise dodecanethiol, alkythiol, oleylamine, and oleic acid. In various embodiments, each nanoparticle comprises a core with a diameter of about 5.0 nm±0.5 nm. In still other embodiments, the diameter of the core may range from about 3 nm to about 50 nm.

Pores are formed in the interstices between three or more adjacent nanoparticles. In certain embodiments, substantially all pores may have an effective diameter of between about 0.5 nm and about 7 nm. In certain embodiments, substantially all powers have an effective diameter of between about 1.0 nm and 2.5 nm. In specific embodiments, substantially all pores have an effective diameter of about 1.7 nm.

In some embodiments, the film is homogenous, i.e., comprised of nanoparticles comprising the same core material and the same ligand material. In other embodiments, the film is heterogeneous, i.e., comprised of different types of nanoparticles having different core and/or ligand materials.

In still other embodiments, films are disclosed that have, instead of close-packed (i.e., triangular) lattice geometry, a different ordered or disordered particle packing arrangement. In additional embodiments, films are disclosed that possess a packing arrangement resulting from the use of two or more different particle sizes. In yet other embodiments, films are disclosed that possess a packing arrangement resulting from the use of particles that are non-spherical.

Filtration properties may be modified by varying the packing arrangement, particle size, particle shape, and composition of a mixture of heterogeneous particles. By varying the chemical structure of the ligand, the physical and chemical nature of the pore can be changed further. Varying these properties allows for tuning the size and shape of pores within the film, thereby making the filtration of one solute component relative to that of another more or less likely.

Using gold nanoparticle membranes as an example, ultrathin nanoparticle membranes have been shown to demonstrate excellent nanofiltration. Single freestanding nanoparticle monolayers or stacks of two or more freestanding monolayers of close-packed nanoparticles may function as effective nanofilters to precisely separate “objects,” which include but are not limited to ions, molecules, macromolecular structures, proteins, polymers, antibiotics, DNA, or nanoparticles.

In specific embodiments (e.g., as discussed in He et al., Nano Letters 11, 2430-2435, (2011)), a nanofilter comprises a stack of four monolayer membranes, each membrane comprising gold cores approximately 5 nm in diameter that have been coated with dodecanethiol ligands. In these embodiments, the thickness of the stack is less than about 30 nm.

In such embodiments, the effective pore diameter is about 1.7 nm. Accordingly, substantially all objects with an effective diameter greater than 1.7 nm are rejected and are not allowed to pass through the nanofilter.

A portion of objects with a diameter smaller than 1.7 nm may pass through the nanofilter. However, the rejection rate depends on whether the object is charged or neutral. Neutral objects can pass through the nanofilter with an approximately 10%-30% rejection rate, while charged objects may pass through the nanofilter with an approximately 40%-90% rejection rate.

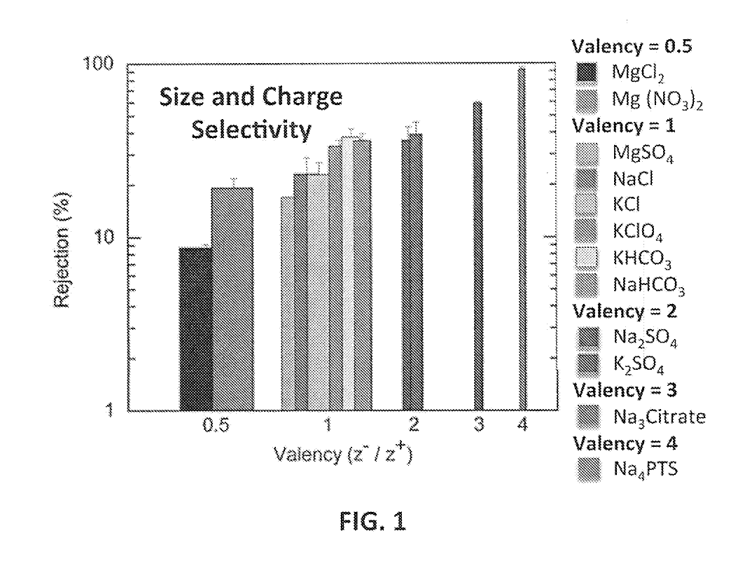

As shown in FIG. 1, the rejection rate depends on the valency of the object as well as the object size (i.e., the effective diameter of the object). For example, MgCl₂ has a valency of 0.5 and a rejection rate of about 8%-9%. Mg(NO₃)₂ has a valency of 0.5 and a rejection rate of about 18%-20%. MgSO₄ has a valency of 1 and a rejection rate of about 16%. NaCl has a valency of 1 of a rejection rate of about 20%-30%. KCl has a valency of 1 and a rejection rate of about 20%-30%. KClO₄ has a valency of 1 and a rejection rate of about 30%-35%. KHCO₃ has a valency of 1 and a rejection rate of about 35%-40%. NaHCO₃ has a valency of 1 and a rejection rate of about 32%-34%. Na₂SO₄ has a valency of 2 and a rejection rate of about 30%-42%. K₂SO₄ has a valency of 2 and a rejection rate of about 35%-45%. Na₃Citrate has a valency of 3 and a rejection rate of about 60%. Na₄PTS has a valency of 4 and a rejection rate of about 90%-95%.

Accordingly, disclosed embodiments of nanoparticle films may be used to remove salts from water, (i.e., in desalinization processes) as well as to remove other contaminants or undesired molecules from a fluid. In addition, disclosed embodiments of nanoparticle films may be used to retain desired objects larger than the effective pore size, thereby concentrating those objects on the input side of the filter (i.e., as in concentrating whey in dairy production; concentrating fruit juice in fruit juice production; concentrating effective compounds as in drug production).

### First Experimental Example

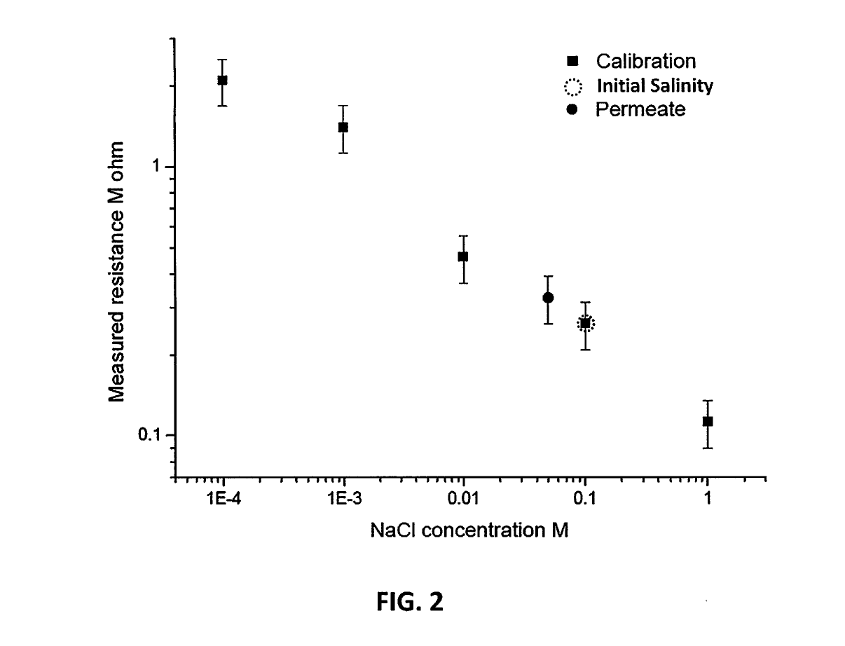

Preliminary tests were conducted to determine the effectiveness of salt ion rejection by the embodiment of a nanoparticle filtration film as described above. Data from one of these tests are shown in FIG. 2. The measured resistance in megaohms (MΩ) is shown as a function of NaCl concentration (mol) in a saltwater solution. As the molar concentration of NaCl decreases the measured resistance increases, as shown by the squares labeled “Calibration.”

The initial concentration of NaCl was 0.1 M, as shown by the dashed circle labeled “Initial Salinity.” After the saltwater solution was passed through one nanoparticle filtration film, the concentration of NaCl decreased to ˜0.05 M, as shown by the circle labeled “Permeate.”

Thus, the preliminary results show that for 0.1 M NaCl, the rejection rate is 40% ±20%. This implies that the rejection does not diminish much, if at all, for much smaller molecular species than shown in the abovementioned 2011 paper by He et al. and thus demonstrates the capacity of this system to serve as filter for charged ions in aqueous solution.

### Second Experimental Example

Preliminary tests were conducted on a second embodiment of a nanoparticle filtration film. Each nanoparticle in the film comprised an Fe/Fe₃O₄ core having a diameter of about 13 nm and was coated with an oleic acid ligand.

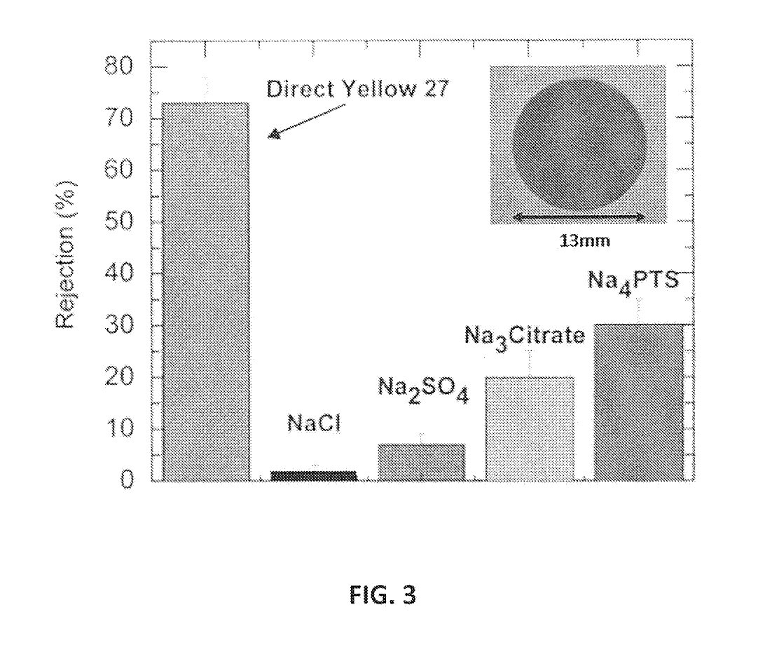

As in the gold-core embodiment discussed above, molecule-specific particle rejection was observed. For example, as illustrated in FIG. 3, direct yellow 27 had a rejection rate of between about 72% and about 77%; NaCl had a rejection rate of between about 2% and about 3%; Na₂SO₄ had a rejection rate between about 6% and 9%; Na₃Citrate had a rejection rate between about 20% and about 25%; and Na₄PTS had a rejection rate between about 30% and 35%.

### Fabrication

An approach based on self-assembled colloidal nanoparticles can decrease the thickness of a filtration membrane by at least an order of magnitude, down to between 30-50 nanometers or possibly the thickness of a single monolayer of nanoparticles, typically about 6-8 nm. The fabrication technique is based on depositing hydrophobic nanoparticles in an organic solvent around or on top of a water droplet. Alternatively, a Langmuir trough with a suitable subphase (e.g., water for the case that the nanoparticle ligands are hydrophobic) can be used. The fast evaporation of organic solvent facilitates a spontaneous assembly of nanoparticle arrays on top of a water droplet or at the trough surface, and a slow evaporation of water allows the membrane to drape over holes in the substrate to create a free-standing membrane. Such processes have been used to fabricate membranes of different types of nanoparticles (He et al., Small 6 (13), 1449-1456 (2010)).

It should be understood that the present devices and methods are not intended to be limited to the particular forms disclosed. Rather, they are to cover all modifications, equivalents, and alternatives falling within the scope of the claims.

The claims are not to be interpreted as including means-plus- or step-plus-function limitations, unless such a limitation is explicitly recited in a given claim using the phrase(s) “means for” or “step for,” respectively.

We claim:

1. A film comprising:
a plurality of nanoparticles, each nanoparticle comprising a core substantially surrounded by a ligand; and
a plurality of pores each formed by interstices between three or more adjacent nanoparticles, each pore having an effective pore diameter;
where the diameter of each core is less than or equal to about 50 nm and the effective diameter of each of the pores is between about 0.5 nm and about 7 nm; and
where the film is configured to reject at least about 20% of charged objects with a diameter less than the effective pore diameter.

2. The film of claim 1, where in each of at least some of the nanoparticles, the core is selected from the group consisting of Au, Fe/Fe₃O₄, CoO, SiO₂, and CdSe.

3. The film of any of claims 1-2, where in each of at least some of the nanoparticles, the ligand is selected from the group consisting of: dodecanethiol, alkythiol, oleylamine, and oleic acid.

4. The film of claim 1, where in each of at least some of the nanoparticles, the core comprises Au and the ligand comprises dodecanethiol.

5. The film of claim 1, where in each of at least some of the nanoparticles, the core comprises Fe/Fe₃O₄ and the ligand comprises oleylamine.

6. The film of claim 1, where in each of at least some of the nanoparticles, the core comprises CoO and the ligand comprises oleic acid.

7. The film of any of claims 1-6, where the film is configured to reject substantially all objects having an effective diameter greater than the effective port diameter.

8. The film of any of claims 1-7, where the film is configured to reject at least about 45% of charged objects having an effective diameter less than about 1.6 nm.

9. The film of any of claims 1-8, where the film is configured to remove at least about 20% of NaCl from salt water passed through the film.

10. A film comprising:
a plurality of first nanoparticles each comprising a first core substantially surrounded by a first ligand; and
a plurality of second nanoparticles each comprising a second core substantially surrounded by a second ligand;
where the first core and the second core comprise different material and the first ligand and the second ligand comprise different material; and
where the diameter of each of the first and second nanoparticles is less than or equal to about 50 nanometers and the effective diameter of each of the pores is between about 0.5 nm and about 7 nm.

11. The film of claim 10, where in each of at least some of the first and second nanoparticles, the first core and second core are selected from the group consisting of Au, Fe/Fe₃O₄, CoO, SiO₂, and CdSe.

12. The film of any of claims 11-12, where the where in each of at least some of the first and second nanoparticles, the first ligand and second ligand are selected from the group consisting of: dodecanethiol, alkythiol, oleylamine, and oleic acid.

13. The film of any of claims claim 10-12, where the film is configured to reject objects having an effective diameter greater than or equal to 1.7 nm.

14. The film of any of claims 10-13, where the film is configured to reject at least about 45% of charged objects having an effective diameter less than about 1.6 nm.

15. The film of any of claims 10-14, where the film is configured to remove at least about 20% of NaCl from salt water passed through the film.

16. The film of any of claims 10-15, where each of the first nanoparticles has a first diameter, and each of the second nanoparticles has a second diameter that is not equal to the first diameter.

17. A filter comprising one or more film monolayers coupled to a support structure, each film monolayer comprising any of the films of claims 1-16.

18. The filter of any of claim 17, where the thickness of the filter is less than or equal to about 100 nm.

19. A method comprising:
passing a liquid through a film of any of claims 1-16 or a filter of any of claims 17-18.

20. A method comprising:
distributing a solution comprising a liquid and a plurality of the nanoparticles in any of claims 1-17; and
permitting the liquid to evaporate such that the nanoparticles form a film of any of claims 1-17.

21. The method of claim 20, further comprising:
permitting the liquid to evaporate such that the nanoparticles form a plurality of films of any of claims 1-17. The method of claim 21, further comprising:
coupling a plurality of the films together to form a filter.
